(19) United States
(12) Patent Application Publication
(10) Pub. No.: US 2015/0341630 A1
(43) Pub. Date: Nov. 26, 2015

(54) FAULT DETECTION METHOD, FAULT DETECTION DEVICE AND FAULT DETECTION SYSTEM

(71) Applicant: BOE TECHNOLOGY GROUP CO., LTD., Beijing (CN)

(72) Inventor: Yuewei ZHENG, Beijing (CN)

(21) Appl. No.: 14/548,999

(22) Filed: Nov. 20, 2014

(30) Foreign Application Priority Data
May 26, 2014 (CN) 201410225538.2

(51) Int. Cl. H04N 17/04

(52) U.S. Cl. CPC H04N 17/04

(57) ABSTRACT

The present invention provided a fault detection method comprising: S31, acquiring the real-time operation status signal of the display device; S32, comparing the real-time operation status signal of the display device with a predetermined operation status signal and determines whether fault occurs in the display device. The present invention provided a fault detection device and a fault detection system. By means of the fault detection method of the present invention, a faulty display can be determined rapidly. Moreover, because of the few bandwidth required for the operation status signals, the network environment requirement for the fault detection device is low, and the costs of the fault detection for the display device can be lowered.

### FIELD OF THE INVENTION

The present invention relates to the field of detection of the display device, in particular to a fault detection method for detecting fault of the display device, a fault detection device for performing the fault detection method and a fault detection system including the fault detection device.

### BACKGROUND OF THE INVENTION

Now public transports (for example, train, subway, bus, etc.) are usually equipped with display devices for passengers to watch TV programs when traveling.

However, in some cases with poor working environment, display device in the public transport will inevitably fail, thus affecting the normal use of the display device.

Currently two methods can be used to determine whether the display device in the public transport is faulty.

The first method is shown in FIG. 1, the operation condition of each display apparatus 100 in the vehicle is inspected by the workers and is recorded so as to determine the specific location of the faulty display device. However, this approach requires high labor costs and the response is slow.

The second method is shown in FIG. 2, the screen displayed on the display device 100 is captured by the camera 10 and is then sent to the control board 20, and then sent to the wireless communication module 30 by the control board 20, and finally sent to the server 200 by the wireless communication module 30, the server 200 determines whether a fault occurs in the display device 100. However, this method needs to transmit a large amount of data, which requires high network environment quality and wide bandwidth, and is poor in real-time characteristic.

Therefore, there is need in the technical field for determining whether fault occur in the display device of public transport rapidly and with low costs.

### SUMMARY OF THE INVENTION

The object of the present invention is to provide a fault detection method for detecting fault of a display device, a fault detection device for performing the fault detection method and a fault detection system including the fault detection device. By means of the fault detection method and the fault detection device, the location of a faulty display device in the public transport can be determined rapidly and economically.

To achieve the above object, as one aspect of the present invention, there is provided a fault detection method comprising:

S31, acquiring the real-time operation status signal of the display device;

S32, comparing the real-time operation status signal of the display device with a predetermined operation status signal and determines whether fault occurs in the display device.

Preferably, the operation status signal can be at least one of the power supply voltage of the display device, the backlight enable voltage of the backlight of the display device and the regulation voltage of the backlight of the display device.

Preferably, the step S32 comprises:

S32a, performing a first comparison between the real-time operation status signal of the display device and the predetermined operation status signal, so as to determine whether the real-time operation status signal of the display device is in correspondence with the predetermined operation status signal;

If in the step S32a, it is determined that the real-time operation status signal of the display device is not in correspondence with the predetermined operation status signal, then step S32 further comprises:

S32b, starting timing after the first comparison till a second predetermined period expires;

S32c, performing a second comparison between the real-time operation status signal of the display device and the predetermined operation status signal, in the second comparison, if the real-time operation status signal of the display device is not in correspondence with the predetermined operation status signal, it is determined that a fault occurs in the display device; and if the real-time operation status signal of the display device is in correspondence with the predetermined operation status signal, it is determined that no fault occurs in the display device.

Preferably, the step S32b comprises:

S321b, generating a second timing start instruction when the first comparison is finished, and starting timing;

S322b, generating a second timing end instruction after the second predetermined period expires, then proceed to step S32c.

Preferably, the step S31 comprises:

converting the real-time operation status signal of the display device into a digital signal; wherein, in the step S32, the digital signal converted from the real-time operation status signal of the display device is compared with the predetermined operation status signal.

Preferably, the fault detection method further comprises a step S20 prior to the steps S31 and S32:

S20, detecting a fault based on the display color;

wherein said step S20 comprises:

S21, outputting display instruction to the display device, so as to control the display device to be detected to display predetermined color;

S22, acquiring the color value of the actual displayed color of the display device;

S23, comparing the acquired color value in step S22 with the predetermined color value, and determining whether fault occurs in the display device on the basis of the comparison.

Preferably, the predetermined color value is selected from a plurality of different colors. In step S21, a plurality of color display instructions are output to the display device within the first predetermined period, so that the display device is controlled to display a plurality of different colors within the first predetermined period.

Preferably, the step S21 comprises:

S21a, generating a first timing start instruction when the display instruction is output to the display device to be detected;

S21b, outputting the display instructions sequentially to control the display device displaying a plurality of different colors, generating a first timing end instruction after the first predetermined period expires and stop outputting the display instructions.

Preferably, the step S20 comprises:

S24, sending the comparison result to the server;

When it is determined that the display device has fault, the fault detection method further comprises:

S33, sending the fault information to the server.

Preferably, in the step S24, the comparison result is sent to the server using wireless network, and/or in the step S33, the fault information is sent to the server using wireless network.

Preferably, the fault detection method further comprises the following steps prior to the step S20:

S10, initializing the display control unit to detect whether there is fault occurs;

The step S10 comprises:

S11, initializing the display control unit;

S12, determining whether there is fault occurs in the fault detection device based on the initialization result of the display control unit.

Preferably, the step S12 comprises:

S12a, generating a handshake command containing the initialization result of the fault detection device;

S12b, sending the handshake command to the data processing unit;

S12c, the data processing unit determines whether fault occurs in the display control unit depending on whether the handshake command is received.

Preferably, said step S12c comprises:

S121c, the data processing unit sends the response to the display control unit and generates a third timing start instruction;

S122c, generating a third timing end instruction after a third predetermined period expires.

When the display control unit receives the response, the step S12c further comprises:

S123c, the display control unit sends a secondary response to the data processing unit upon the response is received;

If the data processing unit fails to receive the secondary response within the third predetermined period, it is determined that the initialization of the display control unit is not completed;

If the data processing unit receives the secondary response within the third predetermined period, it is determined that the initialization of the display control unit is completed.

Preferably, when fault occurs in the fault detection device, the step S10 further comprises:

S13, sending the initialization result of the fault detection device to the server.

As another aspect of the present invention, there is provided a fault detection device comprising:

status acquiring unit for acquiring the real-time operation status signal of the display device;

data processing unit, which is configured to compare the real-time operation status signal of the display device with a predetermined operation status signal and determines whether fault occurs in the display device; when it is determined that there is fault occurs in the display device, the data processing unit generates fault information.

Preferably, the status acquiring unit may be at least one of a power supply voltage acquiring subunit, a backlight enable voltage acquiring subunit and a backlight regulation voltage acquiring subunit, wherein the power supply voltage acquiring subunit is used for acquiring the power supply voltage of the display device; the backlight enable voltage acquiring subunit is used for acquiring the backlight enable voltage of the backlight of the display device, and the backlight regulation voltage acquiring unit is used for acquiring the regulation voltage of the backlight of the display device.

Preferably, the fault detection device comprises an A/D converter, the A/D converter is configured for converting the real-time operation status signal of the display device into a digital signal; and the data processing unit compares the real-time operation status signal of the display device which has been converted into digital signal with the predetermined operation status signal.

Preferably, the data processing unit comprises:

a signal comparison subunit, the signal comparison subunit is used for performing a first comparison between the real-time operation status signal of the display device and the predetermined operation status signal, so as to determine whether the real-time operation status signal of the display device is in correspondence with the predetermined operation status signal; if it is determined that the real-time operation status signal of the display device is not in correspondence with the predetermined operation status signal, after a second predetermined period after the first comparison, the signal comparison subunit performs a second comparison between the real-time operation status signal of the display device and the predetermined operation status signal; in the second comparison, if the real-time operation status signal of the display device is not in correspondence with the predetermined operation status signal, the signal comparison subunit generates a fault signal using the real-time operation status signal of the display device; and

a fault information generating subunit, the fault information generating subunit generates a fault information based on the fault signal and the physical address of the faulty display device.

Preferably, the fault detection device further comprises a display control unit, the display control unit comprises a display instruction generating subunit, the display instruction generating subunit is configured for generating and outputting display instruction to the display device, the display instruction controls the display device to display predetermined color;

wherein the status acquiring unit further comprises a color acquiring subunit for acquiring the color value of the actual displayed color of the display device;

wherein the data processing unit further comprises a color comparison subunit for comparing the acquired color value acquired by the color acquiring subunit with the predetermined color value, and obtaining a comparison result.

Preferably, the predetermined color value is selected from a plurality of different colors. The display instruction generating subunit generates and outputs a plurality of color display instructions, which control the display device to display a plurality of different colors within the first predetermined period.

Preferably, the display control unit is communicated with the data processing unit through serial ports.

The display control unit further comprises a handshake command sending subunit which sends the handshake command to the data processing unit after the initialization of the display control unit is finished, the handshake command containing the initialization result of the display control unit.

The data processing unit further comprises a response subunit, the response subunit is used for sending a response to the display instruction generating subunit of the display control unit when the data processing unit receives the handshake command, so as to control the display instruction generating subunit to generates the display instruction; the response subunit is also used for generating an information regarding the display control unit is not initialized normally if the handshake command is not received.

Preferably, the display device is communicated with the data processing unit through serial ports. The data processing unit further comprises a color reading command subunit, the color reading command subunit is used for sending a command of collecting the color value of the colors displayed on the display device to color sensors upon receipt of a response from the display device that the color display is finished. The color sensor is configured for collecting the color value of the colors displayed on the display device.

Preferably, the display control unit further comprises a secondary response subunit, the secondary response subunit is used for sending the secondary response to the data processing unit upon receipt of said response;

if the secondary response is not received within the third predetermined period after the response subunit of the data processing unit sending the response, the response subunit of the data processing unit resends the response to the display control unit; if the response subunit of the data processing unit still cannot receive the secondary response from the display control unit after resending the response, the response subunit of the data processing unit will generate an information that the display control unit is not initialized normally.

Preferably, the third predetermined period is in the range from 5 ms to 20 ms.

Preferably, the fault detection device comprises a timer,

a first timing start instruction is sent to the timer when the display instruction is output from the display instruction generating subunit; after a first predetermined period expires, the timer sends a first timing end instruction to the display instruction generating subunit, so as to control the display instruction generating subunit stop outputting the display instructions; and/or

the signal comparison subunit sends a second timing start instruction to the timer when the first comparison result is generated, and after the second predetermined period expires, the timer sends a second timing end instruction to the signal comparison subunit, so as to control the signal comparison subunit perform the second comparison between the real-time operation status signal of the display device and the predetermined operation status signal; and/or

the response subunit of the data processing unit sends the third timing start instruction to the timer after the response is sent, and after the third predetermined period expires, the timer sends a third timing end instruction to the response subunit of the data processing unit, so as to control the response subunit of the data processing unit stop sending the response.

As a further aspect of the present invention, there is provided a fault detection system comprising: a plurality of signal collection units and the fault detection device of the present invention described above, the signal collection unit is capable of collecting the real-time operation status signal of the display device and sending the operation status signal to the status acquiring unit of the fault detection device.

Preferably, the signal collection unit may be at least one of a power supply voltage collection subunit, a backlight enable voltage collection subunit and a backlight regulation voltage collection subunit, wherein the power supply voltage collection subunit is used for collecting power supply voltage of the display device; the backlight enable voltage collection subunit is used for collecting the backlight enable voltage of the backlight of the display device, and the backlight regulation voltage collection subunit is used for collecting the regulation voltage of the backlight of the display device.

Preferably, the fault detection system comprises color sensors, the color sensor is capable of collecting the color value of the color displayed on the display device, and sending the collected color value to the data processing unit.

Preferably, the fault detection system comprises a server and communication units, the communication unit can send the comparison result and/or the fault information to the server.

Preferably, the communication unit communicates with the server through the wireless network and includes SIM cards.

Typically, the operation status signals of a display device are various voltage signal or current signal, such operation status signals consume few bandwidth when transmitted, therefore the operation status signal of a display device can be transmitted rapidly to the fault detection device, and the fault detection method according to the present invention can be utilized to determine whether fault occurs in the display device. Besides, because of the few bandwidth required for the operation status signals, the network environment requirement for the fault detection device is low, and the costs of the fault detection device for the display device can be lowered.

### BRIEF DESCRIPTION OF THE DRAWINGS

FIG. 1 is a schematic flowchart of the first fault determination method for a display device in the prior art.

FIG. 2 is a schematic flowchart of the second fault determination method for a display device in the prior art.

FIG. 3 is a schematic diagram of the fault detection device provided by the present invention.

FIG. 4 is a schematic view showing the connection relationship between the fault detection device of the present invention and the display device.

FIG. 5 is a flowchart of the initialization detection steps and the detection steps before operation of the fault detection method provided by the present invention.

FIG. 6 is a flowchart of the detection steps before operation of the fault detection method provided by the present invention.

FIG. 7 is a flowchart of the detection steps during operation of the fault detection method provided by the present invention.

FIG. 8 is a flowchart of the detection steps during operation using the A/D converter.

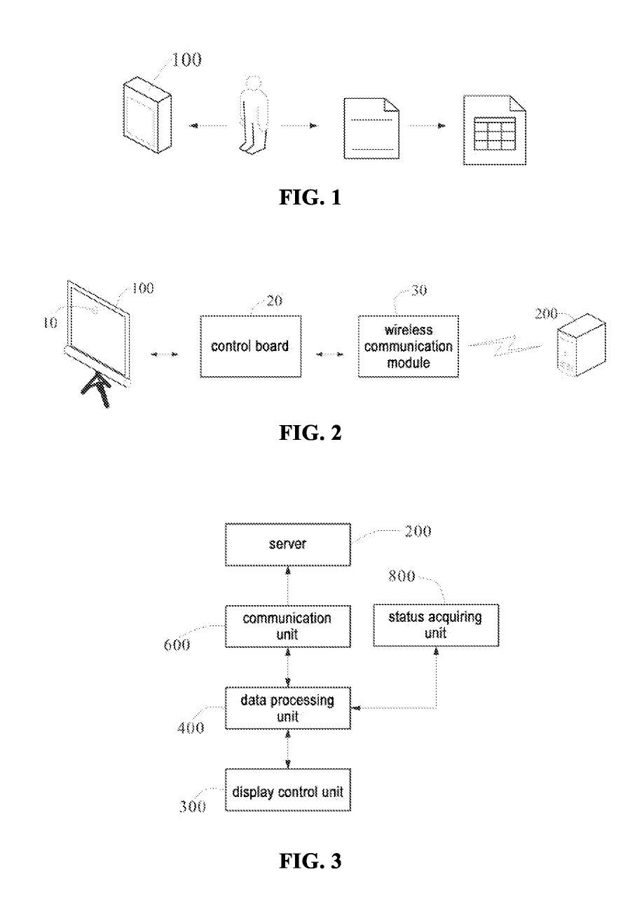

### REFERENCE NUMERALS

| | |
|---|---|
| 10: camera | 20: control board |
| 30: wireless communication module | 100: display device |
| 200: server | 300: display control unit |
| 310: display instruction generating | 320: handshake command |
| subunit | sending subunit |
| 330: the secondary response subunit | 400: data processing unit |
| 410: signal comparison subunit | 420: fault information generation |
| | subunit |
| 430: color reading command subunit | 440: the color comparison subunit |
| 450: response subunit | 500: color sensor |
| 600: communication unit | 700: signal collection unit |
| 710: supply voltage collection | 720: backlight enable voltage |
| subunit | collection subunit |
| 730: backlight regulation voltage | 800: status acquiring unit |
| collection subunit | |
| 810: supply voltage acquiring | 820: backlight enable voltage |
| subunit | acquiring subunit |
| 830: backlight regulation voltage | 840: color acquiring |
| acquiring subunit | subunit |
| 900: timer | |

### DETAILED DESCRIPTION OF THE EMBODIMENTS

Detailed implementations of the present invention will be described below in details in conjunction with accompanying drawings. It is apparent that the embodiments described herein are merely illustrative and used for explaining the present invention, rather than limitation to the present invention.

As one aspect of the present invention, there is provided a fault detection method which comprises:

S31, acquiring the real-time operation status signal of the display device;

S32, comparing the real-time operation status signal of the display device with a predetermined operation status signal and determines whether fault occurs in the display device.

It is apparent that the fault detection method is implemented by fault detection device. Typically, the operation status signals of a display device are various voltage signal or current signal, such operation status signals consume few bandwidth when transmitted, therefore the operation status signal of a display device can be transmitted rapidly to the fault detection device, and the fault detection is performed by the fault detection device.

In other words, according to the fault detection method of the present invention, it can be quickly determined whether fault occurs in a display device. In prior art, when the display device is detected for faults using the manner shown in FIG. 2, pictures are transmitted between the main board 20 and the wireless communication module 30, which need bandwidth of at least several M. In the present invention, the operation status signal itself is typically no larger than 1M, and therefore the bandwidth required for transmitting the operation status signal is less than 1M. Compared to the pictures, the operation status signal consumes less bandwidth, thus the network environment requirement of the fault detection device is lowered and the cost of fault detection for the display device is reduced.

When fault in the display device is detected using the fault detection method, fault information can be generated. If it is determined that there is fault occurs in the display device, the fault information can be sent to the server side for remote monitor by maintenance workers (that is, the fault detection method further comprises: S33, sending the fault information to the server when fault occurs in the display device). Of course, the fault information may be also transmitted to the alarm unit to remind staff on the transports.

As a preferable embodiment of the invention, the operation status signal can be at least one of the power supply voltage of the display device, the backlight enable voltage of the backlight of the display device and the regulation voltage of the backlight of the display device.

Preferably, the fault information includes fault signal and the physical address of the display device where fault occurs, wherein said fault signal is a signal different from the predetermined operation status signal, among the operation status signals of the display device collected by the data collection device.

As described above, the operation status signal can be at least one of the power supply voltage of the display device, the backlight enable voltage of the backlight of the display device and the regulation voltage of the backlight of the display device, and few bandwidth is consumed when transmitting the operation status signals, therefore the network environment requirement of the fault detection method of the present invention is lowered. Moreover, the fault information also consumes few bandwidth, therefore the fault information can be transmitted to the server rapidly and economically, so as for notifying the maintenance workers the display device where fault occurs during operating.

Furthermore, the maintenance workers can judge the fault reason of the faulty display device based on the fault information received from the server. When the transports carrying the display device stops traveling, the maintenance workers can perform maintenance or replacement to the faulty display device based on the judgment result from the server.

Since the signals received by the display device may be instable during traveling of the transports, in order to ensure accuracy of detection result, the step S32 preferably comprises:

S32a, performing a first comparison between the real-time operation status signal of the display device and the predetermined operation status signal, so as to determine whether the real-time operation status signal of the display device is in correspondence with the predetermined operation status signal;

If in the step S32a, it is determined that the real-time operation status signal of the display device is not in correspondence with the predetermined operation status signal, then step S32 further comprises:

S32b, starting timing after the first comparison till a second predetermined period expires;

S32c, performing a second comparison between the real-time operation status signal of the display device and the predetermined operation status signal, in the second comparison, if in the second comparison, the real-time operation status signal of the display device is not in correspondence with the predetermined operation status signal, it is determined that a fault occurs in the display device; and if the real-time operation status signal of the display device is in correspondence with the predetermined operation status signal, it is determined that no fault occurs in the display device.

There may be two reasons causing that the real-time operation status signal of the display device is not in correspondence with the predetermined operation status signal in the first comparison of step S32a: firstly, the signal provided to the display device in interrupted for short time; secondly, there is fault occurs in the display device.

If it is the first reason causing that the real-time operation status signal of the display device is not in correspondence with the predetermined operation status signal in the first comparison of step S32a, then after the second predetermined period expires (i.e. the signal provided to the display device recovers), when the second comparison in step S32c is performed, the real-time operation status signal of the display device will be in correspondence with the predetermined operation status signal again, which means no fault occurs in the display device. If it is the second reason causing that the real-time operation status signal of the display device is not in correspondence with the predetermined operation status signal in the first comparison of step S32a, then after the second predetermined period expires, when the second comparison in step S32c is performed, the real-time operation status signal of the display device is still not in correspondence with the predetermined operation status signal, it can be determined that there is fault occurs in the display device.

In order to control the second predetermined period precisely, the step S32b preferably comprises:

S321b, generating a second timing start instruction when the first comparison is finished, and starting timing;

S322b, generating a second timing end instruction after the second predetermined period expires, then proceed to step S32c.

The second predetermined period may be determined depending on the operation status of the display device. For example, the second predetermined period may be selected within a range from 5 s to 10 s.

To further improve the efficiency of fault detection, the step S31 preferably comprises:

converting the real-time operation status signal of the display device into digital signal; wherein, in the step S32, the digital signal converted from the real-time operation status signal of the display device is compared with the predetermined operation status signal.

It is apparent that the predetermined operation status signal here is also digital signal.

In order to detect fault in the display device in time and perform service to the display device in time, preferably, the fault detection method further comprises a step S20 prior to the steps S31 and S32:

S20, detecting a fault based on the display color;

wherein said step S20 comprises:

S21, outputting display instruction to the display device, so as to control the display device to be detected to display predetermined colors;

S22, acquiring the color value of the actual displayed color of the display device;

S23, comparing the acquired color value in step S22 with the predetermined color value, and obtaining the comparison result.

Based on the comparison result, it can be determined whether fault occurs in the display device before normal operation. If the acquired color value in step S22 is in correspondence with the predetermined color value, it shows that no fault occurs in the display device before normal operation; and if the acquired color value in step S22 is not in correspondence with the predetermined color value, it is determined that fault occurs in the display device before normal operation.

Also, the comparison result can be sent to the server side for remote monitor by maintenance workers (that is, the step S20 further comprises: S24, sending the fault information to the server when fault occurs in the display device). Of course, the comparison result may be also transmitted to the alarm unit to remind workers on the transports.

As such, the object of step S20 is to detect the display device before normal operation so as to determine whether there is faulty display device. After step S20, if there is faulty display device exist, the display signal is no longer provided to the faulty display device. Generally, the color value is a series of numerals, which consumes very few bandwidth when the color value is transmitted, and has low requirement for the network environment, such that the faulty display device can be determined rapidly and economically.

In order to determine whether there is fault occurs in the display devices accurately, preferably, the predetermined color value is selected from a plurality of different colors. In step S21, a plurality of color display instructions are output to the display device within the first predetermined period, so that the display device is controlled to display a plurality of different colors within the first predetermined period.

Preferably, the step S21 comprises:

S21a, generating a first timing start instruction when the display instruction is output to the display device to be detected;

S21b, outputting the display instructions sequentially to control the display device displaying a plurality of different colors, generating a first timing end instruction after the first predetermined period expires and stop outputting the display instructions.

For example, the predetermined color may include red, green, and blue, and the display device can be controlled to display red, green, and blue sequentially in a predetermined time. If the color values collected in step S22 is not in strict correspondence with the predetermined color values to be sequentially displayed, it is determined that the display device is faulty.

As to the implementation of sending the fault information and/or comparison result to the server, the manner of transmitting the fault information and/or comparison result is not particularly limited. As described above, the transmission of fault information and the comparison result consume few space, preferably, in step S33, the fault information can be sent to the server using wireless network (e.g., GSM network); and/or, in the step S24, the comparison results can be sent to the server using wireless network (e.g., GSM network).

As described above, the fault detection method of the present invention is implemented using corresponding fault detection device. If fault occurs in the fault detection device performing the fault detection method, the fault detection to the display device is unavailable.

In order to determine whether the fault detection device performing the fault detection method is faulty, preferably, the fault detection method further comprises a step S10 prior to the step S20:

S10, initializing the display control unit to detect whether there is fault occurs;

The step S10 comprises:

S11, initializing the display control unit;

S12, determining whether there is fault occurs in the fault detection device based on the initialization result of the display control unit.

There are two initialization results, i.e. the display control unit to perform step S20 is initialized normally; and the display control unit to perform step S20 is not initialized normally, which means fault occurs in the display control unit to perform step S20 and the display control unit needs maintenance.

The step S12 comprises:

S12a, generating a handshake command containing the initialization result of the fault detection device;

S12b, sending the handshake command to the data processing unit;

S12c, the data processing unit determines whether fault occurs in the display control unit depending on whether the handshake command is received by the data processing unit.

Preferably, said step S12c comprises:

S121c, the data processing unit sends response to the display control unit and generates a third timing start instruction;

S122c, generating a third timing end instruction after a third predetermined period expires.

When the display control unit receives the response, the step S12c further comprises:

S123c, the display control unit sends a secondary response to the data processing unit upon receipt of the response;

If the data processing unit fails to receive the secondary response within the third predetermined period, it is determined that the initialization of the display control unit is not completed;

If the data processing unit receives the secondary response within the third predetermined period, it is determined that the initialization of the display control unit is completed.

If it is determined that there is fault occurs in the display control unit for performing step S20, the initialization result can be sent to the server for remote monitor by maintenance workers (that is, when fault occurs in the fault detection device, the step S10 further comprises: S13, sending the initialization result of the fault detection device to the server); alternately, when fault occurs in the fault detection device, the initialization result may be also transmitted to the alarm means on the transports, so as to remind staff on the transports to perform monitor.

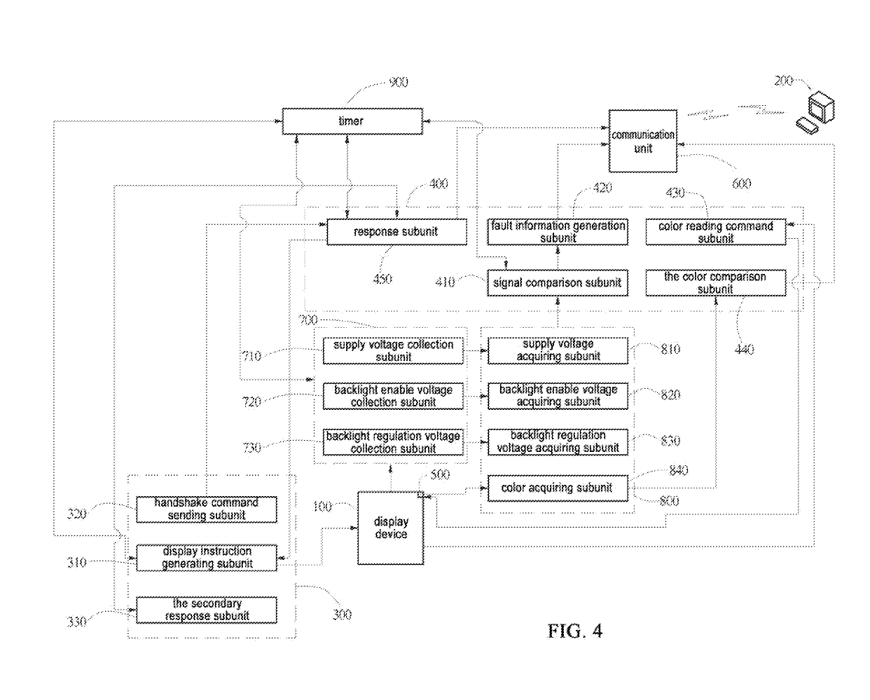

As another aspect of the present invention, there is provided a fault detection device for detect fault in a display device, the fault detection device can implement the fault detection method described above. To implement the fault detection method of the present invention, as shown in FIGS. 3 and 4, the fault detection device comprises: a status acquiring unit 800 (for performing step S31) and a data processing unit 400 (for performing step S32). The status acquiring unit 800 is capable for acquiring the real-time operation status signal of the display device 100, and sending the real-time operation status signal of the display device 100 to the data processing unit 400; the data processing unit 400 is configured to compare the real-time operation status signal of the display device 100 with a predetermined operation status signal and determines whether fault occurs in the display device 100; when it is determined that there is fault occurs in the display device 100, the data processing unit 400 generates fault information.

As described above, the operation status signals of a display device are various voltage signal or current signal, such operation status signals consume few bandwidth when transmitted, therefore the operation status signal of a display device can be transmitted rapidly to the fault detection device.

As described above, the operation status signal can be at least one of the power supply voltage of the display device, the backlight enable voltage of the backlight of the display device and the regulation voltage of the backlight of the display device. Accordingly, the status acquiring unit 800 may be at least one of a power supply voltage acquiring subunit 810, a backlight enable voltage acquiring subunit 820 and a backlight regulation voltage acquiring subunit 830, wherein the power supply voltage acquiring subunit 810 is used for acquiring the power supply voltage of the display device; the backlight enable voltage acquiring subunit 820 is used for acquiring the backlight enable voltage of the backlight of the display device, and the backlight regulation voltage acquiring unit 830 is used for acquiring the regulation voltage of the backlight of the display device.

As described above, the operation status signal includes the power supply voltage of the display device 100, the backlight enable voltage of the backlight of the display device 100 and the regulation voltage of the backlight of the display device 100. Accordingly, the predetermined operation status signal includes the predetermined power supply voltage of the display device 100, the predetermined backlight enable voltage of the backlight of the display device 100 and the predetermined regulation voltage of the backlight of the display device 100. When the following at least one condition occurs, the display device 100 can be determined a failure has occurred: the power supply voltage of the display device 100, the backlight enable voltage of the backlight of the display device 100 or the regulation voltage of the backlight of the display device 100 is not in correspondence with the predetermined operation status signal includes the predetermined power supply voltage of the display device 100, the predetermined backlight enable voltage of the backlight of the display device 100 and the predetermined regulation voltage of the backlight of the display device 100.

In the present invention, a signal acquisition unit 700 may be integrated in a display device, to save the installation space of said fault detection device.

The data processing unit may directly compare the analog signals (i.e., the real-time signal and the predetermined operating state of the operating condition signal are analog values), or compare the digital signals (i.e., the real-time operation status signal is converted to a digital signal, then the form of the digital signal of the predetermined operation state signal is compared thereto). In order to increase the speed of comparison, as a preferred embodiment of the present invention, the analog signals can be compared, in particular, the fault detection device further includes an analog to digital converter (ADC), the analog to digital converter is capable of the converting the real-time operation status signal of the display device into a digital signal, the data processing unit can compare the real-time operation status signal of the display device converted into a digital signal with the predetermined operation status signal of the display device.

As described above, in order to determine the location and reason of the faulty display device, preferably, the fault information includes fault signal and the physical address of the display device where fault occurs, wherein said fault signal is a signal different from the predetermined operation status signal, among the operation status signals of the display device collected by the data collection device.

Accordingly, the data processing unit comprises: a signal comparison subunit 410, the signal comparison subunit 410 is used for performing a first comparison between the real-time operation status signal of the display device and the predetermined operation status signal, so as to determine whether the real-time operation status signal of the display device is in correspondence with the predetermined operation status signal; if it is determined that the real-time operation status signal of the display device is not in correspondence with the predetermined operation status signal, after a second predetermined period after the first comparison, the signal comparison subunit performs a second comparison between the real-time operation status signal of the display device and the predetermined operation status signal; in the second comparison, if the real-time operation status signal of the display device is not in correspondence with the predetermined operation status signal, the signal comparison subunit generates a fault signal using the real-time operation status signal of the display device; and

a fault information generating subunit 420, the fault information generating subunit 420 generates a fault information based on the fault signal and the physical address of the faulty display device.

As described above, there are to determination result of the first comparison: the real-time operation status signal of the display device is not in correspondence with the predetermined operation status signal, and the real-time operation status signal of the display device is in correspondence with the predetermined operation status signal. The second comparison is used for eliminate the affection caused by instability of the signal received by the display device to the fault detection result, to ensure accuracy of detection result.

To facilitate timing of the second predetermined period, preferably, the fault detection device comprises a timer 900, the signal comparison subunit sends a second timing start instruction to the timer 900 when the first comparison result is generated, and after the second predetermined period expires, the timer 900 sends a second timing end instruction to the signal comparison subunit, so as to control the signal comparison subunit perform the second comparison between the real-time operation status signal of the display device and the predetermined operation status signal.

In order to find fault in the display device in time (i.e. perform step S20) and maintain the display device in time, the fault detection device further comprises a display control unit 300, the display control unit 300 comprises a display instruction generating subunit 310, the display instruction generating subunit 310 is configured for generating and outputting display instruction to the display device 100, the display instruction controls the display device 100 to display predetermined color. In this situation the status acquiring unit 800 further comprises a color acquiring subunit 840 for acquiring the color value of the actual displayed color of the display device. Accordingly, the data processing unit 400 further comprises a color comparison subunit 440 for comparing the color value collected by the color sensor with the predetermined color value, and obtaining a comparison result.

The comparison result includes two cases: the first case is that the predetermined color value is in correspondence with the color value collected by the color sensor, and the second one is that the predetermined color value is not in correspondence with the color value collected by the color sensor. When the server 200 receives the comparison result that the predetermined color value is in correspondence with the color value collected by the color sensor, it is determined that no fault occurs in the display device; and when the server 200 receives the comparison result that the predetermined color value is not in correspondence with the color value collected by the color sensor, it is determined that a fault occurs in the display device.

Specifically, the display instruction generating subunit 310 of the display control unit 300 generates and outputs display instruction to the display device 100, the display instruction controls the display device 100 to display predetermined color (e.g. red). After the display device 100 performs display, the data processing unit 400 acquires the actually displayed color value (the color value is typically numerals). The data processing unit 400 then compares the predetermined color value with the color value acquired by the data processing unit 400.

In the present invention, the data processing unit 400 acquires the color value which consumes very few bandwidth when the color value is transmitted. Moreover, the comparison result is also digital value and is easy to be sent to remote server or to the alarming device of process. As such, the display device if detected by the fault detection system provided by the present invention, so as to determine the faulty display device rapidly and economically.

In the present invention, the specific color of the predetermined color is not particularly specified. In order to determine whether there is fault occurs in the display devices accurately, preferably, the predetermined color comprises a plurality of different colors. The display control unit 300 is capable of outputting a plurality of color display instructions, so as to control the display device 100 to display plurality of different colors within the first predetermined period.

For example, the predetermined color may include red, green, and blue. The display control unit 300 outputs to the display device 100 the instructions of displaying red, green, and blue sequentially. If the data processing unit 400 acquires the red, green, and blue color values respectively, it shows that no fault occurs in the display device 100 before normal operation; and if the data processing unit 400 cannot acquires any one of the red, green, and blue color values in this display sequence, it is determined that fault occurs in the display device 100 before normal operation.

A first timing start instruction is sent to the timer 900 when the display instruction is output from the display instruction generating subunit; after a first predetermined period expires, the timer 900 sends a first timing end instruction to the display instruction generating subunit, so as to control the display instruction generating subunit stop outputting the display instructions.

Before normal display of the display device 100, predetermined colors can be displayed on the display device 100 under control of the display control unit 300. If in this stage the display device 100 is determined as not faulty, the program signals can be output to the display device 100 to perform normal display; if it is determined in this stage that there is fault occurs in the display device 100, the faulty display device 100 can be maintained or replaced.

As an embodiment of the present invention, the display control unit 300 is communicated with the data processing unit 400 through serial ports. The display control unit 300 further comprises a handshake command sending subunit 320 which sends the handshake command to the data processing unit 400 after the initialization of the display control unit 300 is finished, the handshake command containing the initialization result of the display control unit.

The data processing unit 400 further comprises a response subunit 450, the response subunit 450 is used for sending a response to the display instruction generating subunit 310 of the display control unit 300 when the data processing unit 400 receives the handshake command, so as to control the display instruction generating subunit 310 to generates the display instruction; the response subunit 450 is also used for generating an information regarding the display control unit is not initialized normally if the handshake command is not received.

Each time a color is output by the display device (i.e. display a color), a response of color output completion will be sent to the data processing unit. The data processing unit, upon receipt of the response, sends the command of reading the color value of the color displayed on the display device to the color sensor, the color sensor is used for collecting the color of the picture actually displayed on the display device (details are described hereinafter). The data processing unit 400 further comprises a color reading command subunit 430, the color reading command subunit 430 is used for sending a command of collecting color value of the colors displayed on the display device to color sensors upon receipt of a response from the display device that the color display is finished.

The serial ports device adopted in the present invention may be of the small terminal mode; in order to facilitate data processing, all the data may be the small terminal mode data.

Since the serial ports device between the display control unit and the data processing unit is preferably a small terminal mode device, the handshake command may has the format as shown in the following Table 1.

TABLE 1

| | | | check |
|---|---|---|---|
| header | command | parameter | code |
| 2 bytes | 1 byte | 1 byte | 1 byte |
| 0xAAAA | 0x01 | 0x01: initialization of the | XOR |
| | | display control unit is | check |
| | | completed; | |
| | | 0x02: initialization of the | |
| | | display control unit failed; | |
| | | others: illegal | |

Since the data processing unit is communicated with the display device via serial ports device, the serial ports device is preferably of a small terminal mode. Therefore, the response of picture output completion sent to the display device may has the format shown in the following Table 2.

TABLE 2

| | | | check |
|---|---|---|---|
| header | command | parameter | code |
| 2 bytes | 1 byte | 1 byte | 1 byte |
| 0xAAAA | 0x02 | 0x01: red picture | XOR |
| | | output completed; | check |
| | | 0x02: green picture | |
| | | output completed; | |
| | | 0x03: blue picture | |
| | | output completed; | |
| | | others: illegal | |

When step S10 of the fault detection method implemented using the fault detection device of the present invention, the step S12 of step S10 may comprises:

S12a, if the response subunit of the data processing unit fails to receive the secondary response from the display control unit within the third predetermined period, the response subunit of the data processing unit sends the response again to the display control unit;

S12b, if the data processing unit still fails to receive the secondary response from the display control unit, the response subunit of the data processing unit generates an information that the initialization of the display control unit is not completed.

Accordingly, the display control unit 300 further comprises a secondary response subunit 330, the secondary response subunit 330 is used for sending the secondary response to the data processing unit 400 upon receipt of said response;

if the secondary response is not received by the data processing unit 400 within the third predetermined period after the data processing unit sending the response, the response subunit 450 of the data processing unit 400 resends the response to the display control unit 300; and if the response subunit 450 of the data processing unit 400 still cannot receive the secondary response from the display control unit 300 after resending the response, the response subunit 450 of the data processing unit 400 will generate an information that the display control unit is not initialized normally.

Preferably, the third predetermined period is in the range from 5 ms to 20 ms. In one embodiment, the third predetermined period may be 10 ms.

the response subunit of the data processing unit sends the third timing start instruction to the timer 900 after the response is sent, and after the third predetermined period expires, the timer 900 sends a third timing end instruction to the response subunit of the data processing unit, so as to control the response subunit of the data processing unit stop sending the response.

The response resent to the display control unit from the data processing unit in step S12a may has the format shown in Table 3.

TABLE 3

| | | | check |
|---|---|---|---|
| header | command | parameter | code |
| 2 bytes | 1 byte | 1 byte | 1 byte |
| 0xAAAA | 0x03 | 0x01: with signal; | XOR |
| | | 0x02: no signal; | check |
| | | others: illegal. | |

The communication unit sends the fault information of the display device to the server via GSM network, the fault information may contain the physical address of the faulty display device. The fault information of the display device sent by the communication unit may have the format shown in Table 4.

TABLE 4

| | | fault | SIM card | check |
|---|---|---|---|---|
| header | command | codes | identification code | code |
| 2 bytes | 1 byte | 2 bytes | 20 bytes | 1 byte |
| 0x5555 | 0x01 | ... ... | ASCII codes | CRC |
| | | | | check |

As a further aspect of the present invention, as shown in FIGS. 3 and 4, there is provided a fault detection system comprising: a plurality of signal collection units 700 and the fault detection device of the present invention described above, each fault detection device corresponds to a display device. The signal collection unit 700 is capable of collecting the real-time operation status signal of the display device and sending the operation status signal of the display device to the data processing unit 400.

The fault detection device may correspond to the signal collection unit 700 in a one-to-one manner or not. For example, a fault detection device may correspond to a plurality of signal collection units 700.

The operation status signal consumes very few bandwidth, such that the real-time operation status signal collected by the signal collection unit 700 can be sent to the data processing unit 400 rapidly, thus the efficiency of the fault detection system can be improved. The signal collection unit 700 can be communicated with the data processing unit 400 via serial ports device.

As mentioned above, the fault detection device comprises a timer 900, after the signal comparison subunit 410 performing a first comparison between the real-time operation status signal of the display device and the predetermined operation status signal, the signal comparison subunit 410 sends a second timing start instruction to the timer 900 when the first comparison result is output, and after the second predetermined period expires, the timer 900 sends a second timing end instruction to the signal collection units 700, the signal collection units 700 continue collecting the real-time operation status signal of the display device after receipt of the second timing end instruction.

Preferably, the signal collection unit 700 comprises at least one of a power supply voltage collection subunit 710, a backlight enable voltage collection subunit 720 and a backlight regulation voltage collection subunit 730, wherein the power supply voltage collection subunit 710 is used for collecting power supply voltage of the display device; the backlight enable voltage collection subunit 720 is used for collecting the backlight enable voltage of the backlight of the display device, and the backlight regulation voltage collection subunit 730 is used for collecting the regulation voltage of the backlight of the display device.

In one embodiment of the fault detection device with a display control unit 300, the fault detection system comprises color sensors 500, the color sensor 500 is capable of collecting the color value of the color displayed on the display device 100, and sending the collected color value to the data processing unit 400. The data processing unit 400 compares the collected color value with the predetermined color value and obtains a comparison result. The color sensor 500 communicates with the data processing unit 400 via serial port device, and in the present invention, the color sensor 500 may be integrated on the display device 100.

For remote monitoring of maintenance workers to the display device, the fault detection system comprises a server 200 and communication units 600, the communication unit 600 can send the comparison result and/or the fault information to the server 200.

It is readily understood that, the initialization result can be sent to the server for remote monitor by maintenance workers. Of course, the response subunit 450 of the data processing unit 400 send the initialization result of the fault detection device to the server, when fault occurs in the fault detection device, the initialization result may be also transmitted to the alarm means on the transports, so as to remind staff on the transports to perform monitor.

Preferably, the communication unit communicates with the server through the wireless network and includes SIM cards.

Since few bandwidth is consumed when transmitting the fault information, therefore the fault information can be transmitted to the server rapidly and economically, so as for notifying the maintenance workers the display device where fault occurs during operating.

the fault information generated by the data processing unit 400 consume few bandwidth, the network environment requirement for transmitting the fault information is low, and the fault information can be sent rapidly and economically to the server 200.

According to the embodiment of the present invention, the fault occurs in the display device can be determined prior to or during normal display of the display device. In other words, the fault detection system of the present invention can determine the faulty display device accurately and in time.

It is readily understood that, the fault detection device of the present invention can be provided on each display device 100 on the transports. When the communication unit 600 of a fault detection device corresponding to the display device 100 sends the comparison result to the server 200, the server 200 is notified with the physical address of the communication unit sending the comparison result and the physical address of the display device corresponding to the communication unit, such that the server can determine whether fault occurs in the display device corresponding to the communication unit sending the comparison result based on the comparison result.

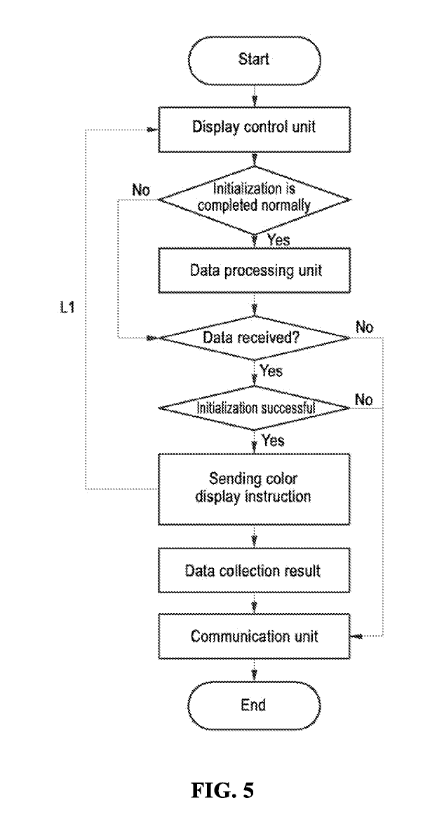

Hereinafter, the workflow of the fault detection method provided by the present invention which is implemented by the fault detection device of the present invention in conjunction with FIGS. 5-8.

As shown in FIG. 5, the display control unit is initialized firstly after power-up (step S11). After the initialization is completed, it is judged that whether the initialization of the display control unit is normally completed.

If the initialization of the display control unit is not normally completed, which means the data processing unit cannot receive the initialization result of the display control unit, then the data processing unit sends the information that the fault occurs in the display control unit to the communication unit.

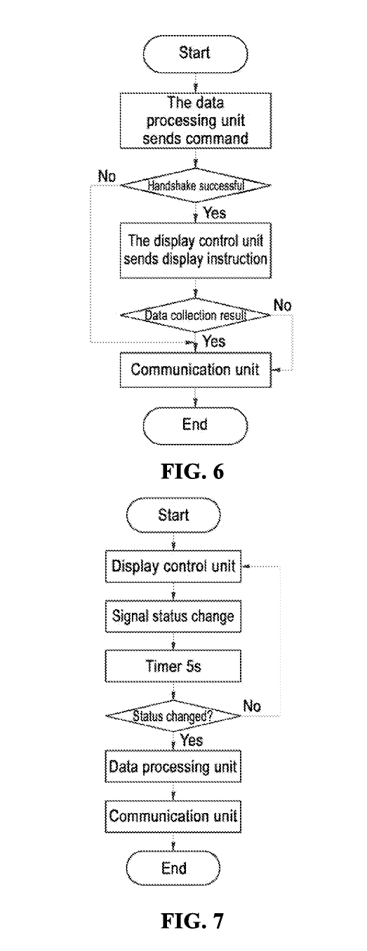

As shown in FIG. 6, if the initialization of the display control unit is normally completed, the initialization result is sent to the data processing unit (i.e. handshake command). When the handshake of the data processing unit and the display control unit is successful, the initialization of the display control unit is successful, the data processing unit sends response to the display control unit, and the display control unit controls the display device to display certain colors after receipt of the response. If handshake fails, the data processing unit sends information that fault occurs in the display control unit to the communication unit, notifying failure of initialization of the display control unit.

Still refer to FIG. 5, upon receipt of the color display instruction from the display control unit, the display result (color value collected by the color sensors) of the display device is collected and sent to the data processing unit. The data processing unit then compares the collected color value with the predetermined color value, and sends the comparison result to the communication unit. As shown in FIG. 5, the display control unit sends a plurality of color display instructions, so as to control the display device to display different colors. FIG. 6 shows the procedure of each color collection (i.e. procedure of step S20), that is, after the display control unit controlling the display device to display certain colors, the collected color value and the predetermined color value is compared by the data processing unit, and the comparison result is sent to the communication unit, no matter whether the comparison result shows consistence.

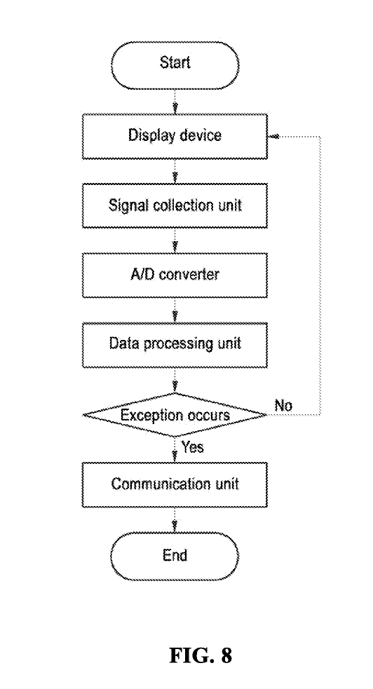

FIGS. 7 and 8 show the flow of the fault detection method of the present invention. After steps S10 and S20, the signal collection unit collects real-time operation status signal of the display device, and when the data processing unit determines that the operation status signal of the display device has changed, the real-time operation status signal of the display device is collected again by the signal collection unit with an interval of 5 s. When the real-time operation status signal of the display device is changed, the data processing unit sends the fault information of the display device to the communication unit; and if the real-time operation status signal of the display device is not changed, the operation status signal of the display device is continually collected by the signal collection unit.

As shown in FIG. 8, the signal collection unit sends the collected real-time operation status signal to the A/D converter, the real-time operation status signal is converted into digital signal and sent to the data processing unit. The data processing unit compares the real-time operation status signal in the form of digital signal with the predetermined status signal and determines whether there is fault occurs (i.e. if fault information exist); when the determination result is that there is fault occurs, the fault information is sent to the communication unit; if not, the status signal of the display device is continually collected.

It should be understood that the above embodiments are just exemplary embodiments for illustrating the principle of the present invention. However, the present invention is not limited thereto. Various variations and improvements can be made by a person skilled in the art without departing from the spirit and essence of the present invention, and these variations and improvements should also be considered to be within the protection scope of the present invention.

1. A fault detection method, comprising:
S31, acquiring a real-time operation status signal of the display device; and
S32, comparing the real-time operation status signal of the display device with a predetermined operation status signal, so as to determine whether fault occurs in the display device.

2. The fault detection method according to claim 1, wherein the operation status signal is at least one of the power supply voltage of the display device, the backlight enable voltage of the backlight of the display device and the regulation voltage of the backlight of the display device.

3. The fault detection method according to claim 1, wherein the step S32 comprises:
S32a, performing a first comparison between the real-time operation status signal of the display device and the predetermined operation status signal, so as to determine whether the real-time operation status signal of the display device is in correspondence with the predetermined operation status signal;
If in the step S32a, it is determined that the real-time operation status signal of the display device is not in correspondence with the predetermined operation status signal, then step S32 further comprises:
S32b, starting timing after the first comparison till a second predetermined period expires;
S32c, performing a second comparison between the real-time operation status signal of the display device and the predetermined operation status signal, in the second comparison, if the real-time operation status signal of the display device is not in correspondence with the predetermined operation status signal, it is determined that a fault occurs in the display device; and if the real-time operation status signal of the display device is in correspondence with the predetermined operation status signal, it is determined that no fault occurs in the display device.

4. The fault detection method according to claim 3, wherein the step S32b comprises:
S321b, generating a second timing start instruction when the first comparison is finished, and starting timing;
S322b, generating a second timing end instruction after the second predetermined period expires, then proceed to step S32c.

5. The fault detection method according to claim 1, wherein the step S31 comprises:
converting the real-time operation status signal of the display device into a digital signal; wherein, in the step S32, the digital signal converted from the real-time operation status signal of the display device is compared with the predetermined operation status signal.

6. The fault detection method according to claim 1, wherein the fault detection method further comprises a step S20 prior to the steps S31 and S32:
S20, detecting a fault based on the display color;
wherein said step S20 comprises:
S21, outputting display instruction to the display device, so as to control the display device to be detected to display predetermined color;
S22, acquiring the color value of the actual displayed color of the display device;
S23, comparing the acquired color value in step S22 with the predetermined color value, and determining whether fault occurs in the display device on the basis of the comparison.

7. The fault detection method according to claim 6, wherein the predetermined color value is selected from a plurality of different colors; in step S21, a plurality of color display instructions are output to the display device within the first predetermined period, so that the display device is controlled to display a plurality of different colors within the first predetermined period.

8. The fault detection method according to claim 7, wherein the step S21 comprises:
S21a, generating a first timing start instruction when the display instruction is output to the display device to be detected;
S21b, outputting the display instructions sequentially to control the display device displaying a plurality of different colors, generating a first timing end instruction after the first predetermined period expires and stop outputting the display instructions.

9. The fault detection method according to claim 6, wherein the step S20 comprises:
S24, sending the comparison result to the server;
When it is determined that the display device has fault, the fault detection method further comprises:
S33, sending the fault information to the server.

10. The fault detection method according to claim 9, wherein in the step S24, the comparison result is sent to the server using wireless network, and/or in the step S33, the fault information is sent to the server using wireless network.

11. The fault detection method according to claim 6, wherein the fault detection method further comprises the following steps prior to the step S20:
S10, initializing the display control unit to detect whether there is fault occurs;
The step S10 comprises:
S11, initializing the display control unit;
S12, determining whether there is fault occurs in the fault detection device based on the initialization result of the display control unit.

12. The fault detection method according to claim 11, wherein the step S12 comprises:
S12a, generating a handshake command containing the initialization result of the fault detection device;
S12b, sending the handshake command to the data processing unit;
S12c, the data processing unit determines whether fault occurs in the display control unit depending on whether the handshake command is received.

13. The fault detection method according to claim 12, wherein said step S12c comprises:
S121c, the data processing unit sends the response to the display control unit and generates a third timing start instruction;
S122c, generating a third timing end instruction after a third predetermined period expires;
when the display control unit receives the response, the step S12c further comprises:
S123c, the display control unit sends a secondary response to the data processing unit upon the response is received;
if the data processing unit fails to receive the secondary response within the third predetermined period, it is determined that the initialization of the display control unit is not completed;
if the data processing unit receives the secondary response within the third predetermined period, it is determined that the initialization of the display control unit is completed.

14. The fault detection method according to claim 11, wherein when fault occurs in the fault detection device, the step S10 further comprises:
S13, sending the initialization result of the fault detection device to the server.

15. A fault detection device comprising:
status acquiring unit for acquiring the real-time operation status signal of the display device;
data processing unit, which is configured to compare the real-time operation status signal of the display device with a predetermined operation status signal and determines whether fault occurs in the display device; when it is determined that there is fault occurs in the display device, the data processing unit generates fault information.

16. The fault detection device according to claim 15, wherein the status acquiring unit may be at least one of a power supply voltage acquiring subunit, a backlight enable voltage acquiring subunit and a backlight regulation voltage acquiring subunit, wherein the power supply voltage acquiring subunit is used for acquiring the power supply voltage of the display device; the backlight enable voltage acquiring subunit is used for acquiring the backlight enable voltage of the backlight of the display device, and the backlight regulation voltage acquiring unit is used for acquiring the regulation voltage of the backlight of the display device.

17. The fault detection device according to claim 15, wherein the fault detection device comprises an A/D converter, the A/D converter is configured for converting the real-time operation status signal of the display device into a digital signal; and the data processing unit compares the real-time operation status signal of the display device which has been converted into digital signal with the predetermined operation status signal.

18. The fault detection device according to claim 15, wherein the data processing unit comprises:
a signal comparison subunit, the signal comparison subunit is used for performing a first comparison between the real-time operation status signal of the display device and the predetermined operation status signal, so as to determine whether the real-time operation status signal of the display device is in correspondence with the predetermined operation status signal; if it is determined that the real-time operation status signal of the display device is not in correspondence with the predetermined operation status signal, after a second predetermined period after the first comparison, the signal comparison subunit performs a second comparison between the real-time operation status signal of the display device and the predetermined operation status signal; in the second comparison, if the real-time operation status signal of the display device is not in correspondence with the predetermined operation status signal, the signal comparison subunit generates a fault signal using the real-time operation status signal of the display device; and
a fault information generating subunit, the fault information generating subunit generates a fault information based on the fault signal and the physical address of the faulty display device.

19. The fault detection device according to claim 15, wherein the fault detection device further comprises a display control unit, the display control unit comprises a display instruction generating subunit, the display instruction generating subunit is configured for generating and outputting display instruction to the display device, the display instruction controls the display device to display predetermined color;
wherein the status acquiring unit further comprises a color acquiring subunit for acquiring the color value of the actual displayed color of the display device;
wherein the data processing unit further comprises a color comparison subunit for comparing the acquired color value acquired by the color acquiring subunit with the predetermined color value, and obtaining a comparison result.

20. The fault detection device according to claim 19, wherein the predetermined color value is selected from a plurality of different colors. The display instruction generating subunit generates and outputs a plurality of color display instructions, which control the display device to display a plurality of different colors within the first predetermined period.

21. The fault detection device according to claim 20, wherein the display control unit is communicated with the data processing unit through serial ports;
the display control unit further comprises a handshake command sending subunit which sends the handshake command to the data processing unit after the initialization of the display control unit is finished, the handshake command containing the initialization result of the display control unit;
the data processing unit further comprises a response subunit, the response subunit is used for sending a response to the display instruction generating subunit of the display control unit when the data processing unit receives the handshake command, so as to control the display instruction generating subunit to generates the display instruction; the response subunit is also used for generating an information regarding the display control unit is not initialized normally if the handshake command is not received.

22. The fault detection device according to claim 21, wherein the display device is communicated with the data processing unit through serial ports. The data processing unit further comprises a color reading command subunit, the color reading command subunit is used for sending a command of collecting the color value of the colors displayed on the display device to color sensors upon receipt of a response from the display device that the color display is finished; the color sensor is configured for collecting the color value of the colors displayed on the display device.

23. The fault detection device according to claim 21, wherein the display control unit further comprises a secondary response subunit, the secondary response subunit is used for sending the secondary response to the data processing unit upon receipt of said response;
if the secondary response is not received within the third predetermined period after the response subunit of the data processing unit sending the response, the response subunit of the data processing unit resends the response to the display control unit; if the response subunit of the data processing unit still cannot receive the secondary response from the display control unit after resending the response, the response subunit of the data processing unit will generate an information that the display control unit is not initialized normally; and
the third predetermined period is in the range from 5 ms to 20 ms.

24. The fault detection device according to claim 23, wherein the fault detection device comprises a timer,
a first timing start instruction is sent to the timer when the display instruction is output from the display instruction generating subunit; after a first predetermined period expires, the timer sends a first timing end instruction to the display instruction generating subunit, so as to control the display instruction generating subunit stop outputting the display instructions; and/or
the signal comparison subunit sends a second timing start instruction to the timer when the first comparison result is generated, and after the second predetermined period expires, the timer sends a second timing end instruction to the signal comparison subunit, so as to control the signal comparison subunit perform the second comparison between the real-time operation status signal of the display device and the predetermined operation status signal; and/or
the response subunit of the data processing unit sends the third timing start instruction to the timer after the response is sent, and after the third predetermined period expires, the timer sends a third timing end instruction to the response subunit of the data processing unit, so as to control the response subunit of the data processing unit stop sending the response.

25. A fault detection system comprising: a plurality of signal collection units and the fault detection device according to claim 15, the signal collection unit is capable of collecting the real-time operation status signal of the display device and sending the operation status signal to the status acquiring unit of the fault detection device.

26. The fault detection system according to claim 25, wherein the signal collection unit may be at least one of a power supply voltage collection subunit, a backlight enable voltage collection subunit and a backlight regulation voltage collection subunit, wherein the power supply voltage collection subunit is used for collecting power supply voltage of the display device; the backlight enable voltage collection subunit is used for collecting the backlight enable voltage of the backlight of the display device, and the backlight regulation voltage collection subunit is used for collecting the regulation voltage of the backlight of the display device.

27. The fault detection system according to claim 25, wherein the fault detection system comprises color sensors, the color sensor is capable of collecting the color value of the color displayed on the display device, and sending the collected color value to the data processing unit.

28. The fault detection system according to claim 27, wherein the fault detection system comprises a server and communication units, the communication unit can send the comparison result and/or the fault information to the server.
